(19) United States
(12) Patent Application Publication
(10) Pub. No.: US 2026/0306997 A1
(43) Pub. Date: Oct. 8, 2026

(54) METHOD OF EXTRACTION OF A GASEOUS OR VAPOR COMPONENT FROM COMPRESSED AIR

(71) Applicants: IES SRL, Legnago (IT); CONSIGLIO NAZIONALE DELLE RICERCHE, Rende (IT)

(72) Inventors: Faccio ENRICO, Legnago (IT); Mariano RIGOTTO, Legnago (IT); Alberto FIGOLI, Rende (IT); Jansen JOHANNES CAROLUS, Rende (IT); Marcello MONTELEONE, Rende (IT); Alessio FUOCO, Rende (IT); Elisa ESPOSITO, Rende (IT)

(21) Appl. No.: 19/472,720

(22) PCT Filed: Apr. 4, 2024
(86) PCT No.: PCT/IB2024/053286

§ 371 Date: Oct. 6, 2025

(30) Foreign Application Priority Data
Apr. 7, 2023 (IT) 102023000006885

(51) Int. Cl. B01D 53/14; B01D 53/18

(52) U.S. Cl. CPC B01D 53/1425; B01D 53/1475; B01D 53/18; B01D 2257/504; B01D 2258/06

(57) ABSTRACT

A method is described for extracting a gaseous or vapor component from compressed air produced by a compressor equipped with a compression chamber. The compressed air in the compression chamber is heated by the compression, is cooled at the outlet of the compression chamber, and sent to a capture device into which an absorbent fluid simultaneously enters and operates to purify it of said component. The absorbent fluid exits enriched of said component from the capture device, is heated by withdrawing heat generated by the compression process occurring in the compression chamber, and then enters a release device wherein said component desorbs into the absorbent fluid to release, at an outlet of the release device, said component extracted from the compressed air.

### TECHNICAL FIELD

The invention relates to an extraction method for a gaseous or vapor component from compressed air, and related apparatus. Specifically, the invention relates to the extraction of CO₂ from the compressed air generated by a compressor provided with a dryer; more specifically, the extraction is carried out by means of a membrane device traversed by an ionic fluid or other type of fluid akin to CO₂.

### background

Many systems exist to capture CO₂ from atmospheric air, but they have high energy expenditure due to air intake and its compression, heat generation, and the generation of cold needed to carry out the process. EP 2 782 657 e.g. is based on the forced re-circulation of conditioned air inside buildings, and the capture of CO₂ is done by solid absorbents. US2022/0305434, on the other hand, describes a process for the direct capture of CO₂ in the air.

A less energy-intensive and widely applicable system would be needed to improve environmental parameters.

### SUMMARY

The main object of the invention is to improve the state of the art, in particular to propose a different extraction and capture method.

Another object of the invention is to exploit the components of a pre-existing compressor to purify the compressed air produced by the compressor from an unwanted gas, e.g. CO₂, or a vapor.

A first aspect of the invention is a method for extracting a gaseous or vapor component from the compressed air produced by a compressor provided with a compression chamber, wherein
the air compressed in the compression chamber is heated by compression, is cooled at the outlet of the compression chamber, preferably by a refrigeration-cycle dryer, and sent to a capture device into which an absorbent fluid simultaneously enters and operates to purify it of said component, and
the absorbent fluid
exits enriched with said component from the capture device,
is heated by withdrawing heat generated by the compression process that takes place in the compression chamber,
and then enters a release device wherein said component desorbs into the absorbent fluid to release, at an outlet of the release device, the gaseous component extracted from the compressed air.

Preferably, the absorbent fluid is cooled or subjected to cooling before entering the capture device.

Another aspect of the invention concerns a method for equipping a pre-existing compressor provided with a compression chamber to make an overall compressed-air purifying device capable of extracting a gaseous or vapor component from the compressed air produced by the compressor,
the compressed air in the compression chamber being heated by the compression,
wherein a capture device and a release device are connected to the compressor,
and an absorbent fluid circuit is provided,
so that
the compressed air at the outlet of the compression chamber is sent to the capture device into which the absorbent fluid simultaneously enters and operates, to purify it from the component,
and so that the absorbent fluid
exits enriched with said component from the capture device,
is heated by withdrawing heat generated by the compression process that takes place in the compression chamber,
and then enters the release device where said component in the absorbent fluid desorbs to release, to an outlet of the release device, said component extracted from the compressed air.

Specifically, in the method the compressed air is cooled at the outlet of the compression chamber. The compressed air may be cooled at the outlet of the compression chamber by a cooling means already present in the compressor, or the cooling means is added to the compressor to perform the cooling function. Preferably the cooling means is a refrigeration-cycle dryer.

The methods are useful e.g. for purifying the air in a compressor's working environment from a gas, such as water vapor, oxygen, argon, helium or CO2 or an organic solvent.

After being cooled, the compressed air is sent to the capture device.

Another aspect of the invention concerns an apparatus provided with means for implementing the method.

The apparatus functions to extract a component, gaseous or vapor, from compressed air, and preferably comprises:
a compressor provided with a compression chamber to produce the compressed air,
a cooling device (preferably a refrigeration-cycle dryer and/or belonging to the compressor) connected downstream of the compression chamber to cool compressed air at the outlet of the compression chamber,
a capture device configured to be passed through simultaneously by
   compressed air coming out of the cooling device and
   an absorbent fluid to purify the compressed air from said component,
a heating device for heating the absorbent fluid exiting the capture device, wherein the heating device is adapted to withdraw heat generated by the compression process occurring in the compression chamber,
a release device configured for
being crossed by the absorbent fluid coming from the heating device and
having said extracted component desorbed from the compressed air.

Preferably the cooling device is a dryer adapted to extract moisture from the compressed air, and even more preferably the dryer operates on a refrigeration cycle.

Preferably the apparatus comprises:
a controller device configured to control the pressure of the absorbent fluid entering the capture device and the pressure of the compressed air entering the capture device and adjust them so that these two pressures are equal; and/or
a heat exchanger adapted to transfer heat from the compressed air to the absorbent fluid exiting the capture device; and/or
a heat sink to cool the compressed air exiting the compression chamber, and a circuit to heat absorbent fluid exiting the capture device by taking heat dissipated from the heat sink; in particular a heat exchanger to transfer heat from the heat sink and/or the compression chamber to the absorbent fluid exiting the capture device; and/or
a circuit to send the absorbent fluid from the cooling device to the inlet of the capture device; and specifically a closed circuit to recirculate the absorbent fluid between the components it passes through sequentially, and/or
a heat exchanger to exchange heat between the cooling device and the absorbent fluid coming from the release device; and/or
a circuit to send the absorbent fluid coming out of the release device to the inlet of the capture device, in particular to the inlet of the cooling device to be cooled; and/or
a heat exchanger adapted to transfer heat between the absorbent fluid exiting the release device and compressed air exiting the capture device for cooling the absorbent fluid and heat the compressed air;
a heat exchanger adapted to transfer heat between the absorbent fluid exiting the capture device and the absorbent fluid leaving the release device, so that the absorbent fluid leaving the capture device heats up and the absorbent fluid exiting the release device cools down.

In general, the methods and the apparatus are applicable to a generic compressed gas or vapor, not only compressed air.

An advantage of the methods and apparatus is that the heating of the absorbent fluid is done by means of the excess heat produced by or available from the compression of the compressed air, with high recovery and energy savings.

Below are preferred variants that can be implemented alone or in combination in the various aforementioned aspects of the invention.

To absorb better, it is preferable for the absorbent fluid to be cooled, and to desorb better it is preferable for it to be heated, and preferably its pressure is reduced. Preferably, the pressure of the absorbent fluid entering the capture device and the pressure of the compressed air entering the capture device are adjusted so that these two pressures are equal.

In a preferred variant, heat acquired from the compressed air during the compression is transferred to absorbent fluid exiting the capture device.

In a preferred variant, the compressed air passes from the compression chamber to a heat sink to be cooled thereat, and the absorbent fluid exiting the capture device is heated by drawing heat dissipated by the heat sink. In a more preferred variation, heat is transferred from the heat sink and/or from the compression chamber to the absorbent fluid exiting the capture device, preferably via a heat exchanger coupled to the heat sink and/or compression chamber.

The method advantageously may involve that the cooling of the compressed air and/or the absorbent fluid occurs by exploiting compressed air already natively cooled in the compressor or in cooling means natively installed in the compressor.

In a preferred variant, the compressed air comes out of the compression chamber, enters a cooling device where it is cooled, and then arrives at the capture device. Preferably the cooling device is a dryer adapted to extract moisture from the compressed air (even more preferably the dryer operates on a refrigeration cycle). In a more preferred variant, the absorbent fluid sent to the inlet of the capture device is cooled in the cooling device or by exchanging heat with the cooling device.

In a preferred variant, the absorbent fluid exiting the release device is recirculated to lead it to the inlet of the capture device, in particular by leading it through the cooling device to be cooled.

In particular, the cooling device is a native component of the compressor.

In a preferred variant, heat is transferred between the absorbent fluid exiting the release device and the compressed air exiting the capture device for cooling the absorbent fluid and heating the compressed air.

In a preferred variant, said component desorbs from the absorbent fluid at atmospheric or reduced pressure.

In a preferred variant, in the release device said component spontaneously desorbs from the absorbent fluid, or, to assist the desorption, the pressure in the second capture device is reduced, e.g. by a vacuum pump.

In a preferred variation, said desorbed component is compressed to store it or to subject it to a further purification stage. The desorbed component may also be cooled to remove condensable components.

In a preferred variant, the absorbent fluid exiting the capture device exchanges heat with the absorbent fluid exiting the release device, so that the absorbent fluid exiting the capture device heats up and the absorbent fluid exiting the release device cools down.

In the various aspects of the invention, preferably the absorbent fluid may be a non-volatile liquid (such as an ionic liquid or porous liquid) or a low volatility liquid (e.g. MEA), preferably non-volatile, and/or the compressed air is sent to the inlet of the first capture device at a temperature of 2+10° C., more preferably 3+5° C.; and/or the absorbent fluid is sent to the inlet of the release device at a temperature of 70-80° C., more preferably 75° C.; and/or the capture device and/or the release device is/are a membrane contactor; and/or said component is e.g. a pollutant or harmful agent, e.g. CO₂.

### BRIEF DESCRIPTION OF THE DRAWINGS

The advantages of the invention will be even clearer from the following description of a preferred extractor device, wherein

FIG. 1 shows a general schematic of the extractor device and its method of operation,

FIG. 2 shows a general schematic of a variant of FIG. 1.

### DETAILED DESCRIPTION

In the figures, the arrows between the blocks indicate a path of fluid or electrical signal. In the figures equal numbers indicate equal components.

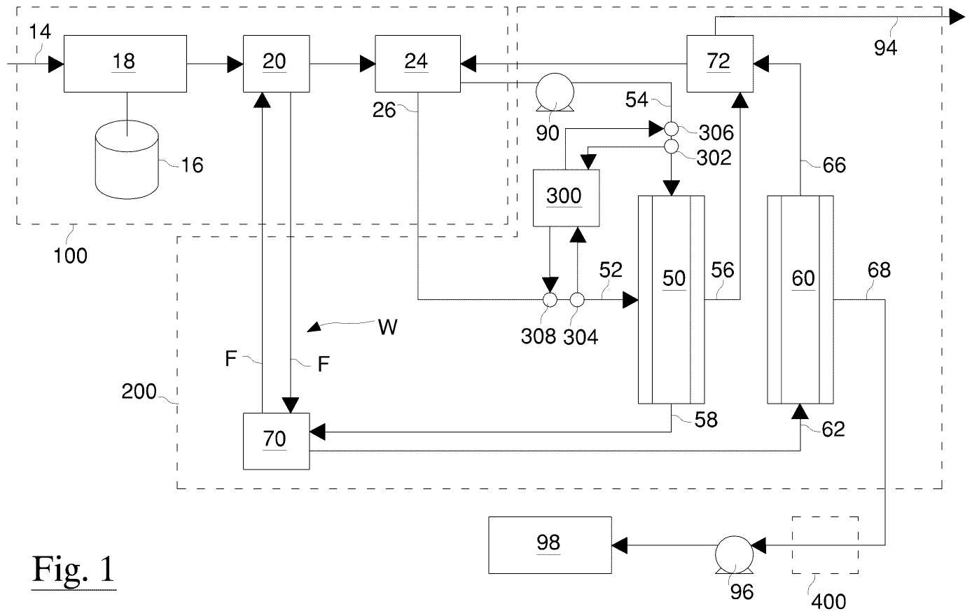

FIG. 1 shows a CO₂ extractor device from compressed air.

A compressor 100 receives at an inlet 14 ambient air and compresses it in known manner inside a compression chamber 18 thanks to mechanical power provided, e.g., by a motor 16. The compressed air heats up in the compression chamber 18 and arrives into a heat exchanger 20 to be cooled. The compressed air from the outlet of the heat exchanger 20 then passes into a dryer 24 where, by cooling, moisture is extracted from the compressed air before making it available cooled at an outlet 26 of the compressor 100.

The heat exchanger 20 is, for example, an air (e.g. finned) and/or oil heat sink.

Preferably the compression chamber 18, the motor 16, the heat exchanger 20, and preferably also the dryer 24, are native components of a pre-existing compressor, here referred to generically with 100 and included in a dashed rectangle. Such components are advantageously coupled to a purification stage 200 (included in a dashed area) and thus also advantageously exploited to extract CO₂ from the compressed air generated at the outlet 26 (which ordinarily a user would exploit in a known manner).

Note that, advantageously, by equipping the pre-existing compressor 100 with the components included in the dashed area 200, it is possible to transform the compressor 100 into a compressed-air purification device capable of extracting a gaseous or vapor component from the compressed air it produces.

The air arriving at the inlet of the purification stage 200 is compressed and also subjected to a cooling process, advantageously by using components that may already be incorporated in the compressor 100.

The compressed air from the outlet 26 is sent to the inlet 52 of a capture device 50 having an inlet 54 for an absorbent fluid, an outlet 56 for compressed air purified from CO₂ and an outlet 58 for the absorbent fluid enriched with the CO₂ subtracted from the compressed air. From the outlet 56, the compressed air exits purified of CO₂. The absorbent fluid exits the dryer 24 and arrives at the inlet 54, passes through the capture device 50, arrives at the outlet 58, and proceeds toward a heater element 70 where it is heated, and the heat for this heating is subtracted from the heat exchanger 20 (or generally from the compression process occurring in the chamber 18). Preferably, the heater element 70 is a heat exchanger in which heat transfer from the heat exchanger 20 to the absorbent fluid takes place. Specifically, the heat transfer occurs via a circuit W of circulating fluid (e.g. oil or water) circulating between the heat exchanger 20 and the heat exchanger 70, see arrows F in FIG. 1.

In a preferred variation, the exchangers 70, 20 are integrated into each other and/or mechanically coupled for maximum thermal efficiency.

The absorbent fluid exits warmer from the heat exchanger 70 and heads to the inlet 62 of a release device 60 having an outlet 66 for absorbent fluid purified from CO₂ and an outlet 68 for the CO₂ released from the absorbent fluid and previously subtracted from the compressed air inside the capture device 50. The CO₂ present at the outlet 68 can then be e.g. stored in a tank 98 for later use. The storage is preferably aided by a pump 96.

From the outlet 66 the absorbent fluid is recirculated to the dryer 24 where it is cooled. To limit the thermal gap in the dryer 24, preferably the purification stage 200 comprises an intermediate heat exchanger 72 that the absorbent fluid traverses before reaching the dryer 24.

Preferably, from the outlet 56 the compressed air is heated approximately to room temperature in order to be then available to a user at an outlet 94. For this purpose, the compressed air is routed through the heat exchanger 72 where it heats and cools the fluid arriving from the outlet 66. Note the advantage given by the heat exchanger 72, which satisfies two process needs: heating the compressed air before the outlet 94 and cooling the absorbent fluid before it reaches the dryer 24.

Note also the advantage of having the hot fluid leaving the device 60 return to the dryer 24 for its cooling. In particular, a preferred structure of the dryer 24 is for it to be a refrigeration-cycle unit with dual internal heat exchangers: one for compressed air and one for liquid.

Preferably the capture device 50 and/or the release device 60 is/are a membrane contactor, for greater process efficiency and small bulk, or a generic membrane device, in which the already cooled compressed air goes into on one side and the pressurized cold fluid on the other side.

In the release device 60 the fluid may also enter depressurized at room pressure. The outlet 68 may communicate directly with the atmosphere or the pump 96.

As preferred operating values, the absorbent fluid has these temperatures: 3 to 5° C. at the inlet 54, about 6° C. at the outlet 58, about 75 to 80° C. at the outlet of the heat exchanger 70, about 65 to 70° C. at the outlet 66, and about 10 to 15° C. at the outlet of the intermediate heat exchanger 72.

As preferred operating values, the compressed air has these temperatures: 5° C. at the outlet of the dryer 24 and the capture device 50, about 75 to 85° C. inside the compression chamber 18 and/or in the heat exchanger 20.

These temperature values are not strictly necessary, but are the operating ones available with the compressor 100 that facilitate the absorption and desorption process.

The purification process may occur thanks to the temperature difference of the absorbent fluid entering the two devices 50, 60: e.g., the absorbent fluid may be at 5 to 25° C. at the inlet 54 and at 50 to 90° C. at the inlet 62. The same process may also occur at the same temperature in the presence of a pressure difference, but for process efficiency it is better to have a temperature difference as well.

The absorbent fluid may be circulated in the described fluid circuit by any known means 90, preferably by a pump. The pump is useful for bringing the absorbent fluid to the same pressure as the compressed air. Another optional component may be a fluid pressure reducer (up to atmospheric pressure) placed between the device 50 and the device 60. e.g. applied downstream of the outlet 58, upstream of the inlet 62, or downstream of the outlet 66.

An auxiliary heat exchanger may be installed to cool the fluid before sending it to the pump 90 applied e.g. between the exchanger 72 and the dryer 24 or between the dryer 24 and the pump 90, and/or a condenser to condense any liquid or moisture that evaporates in the auxiliary heat exchanger.

The absorbent fluid may be a non-volatile liquid (such as an ionic liquid) or a low-volatility liquid (e.g., MEA), preferably non-volatile. To absorb better it is good for it to be cooled, and to desorb better it is good for it to be heated, and preferably its pressure is reduced.

Liquids such as: porous liquids, eutectic liquids, alkaline solutions, or liquids with affinity toward CO₂ may be used as the absorbent fluid.

The dryer 24 may be part of the compressor 100 or the stage 200. The pump 96 and/or the tank 98 are either part of the stage 200 or remotely installed.

Downstream of the outlet 68 (before or after the pump 96) a means 400 may be provided for the recovery of any water or absorbent liquid evaporated during the release of CO₂ from the release device 60. Such a means 400 may be a filter, a conventional condenser, or a membrane condenser. The dryer 24 preferably also comprises an outlet for condensate.

To optimize the process, preferably the fluid pressure at the inlet 54 and the pressure of the compressed air at the inlet 52 are adjusted to be equal. For this purpose, an electronic controller 300 detects these operating pressures by reading the output signals emitted by pressure sensors 302, 304 and adjusts them by driving controllers 306, 308, which e.g. are pressure and/or flow regulators. This control is especially advantageous in the startup and shutdown phases of the system to prevent flooding of the different compartments in the capture device 50.

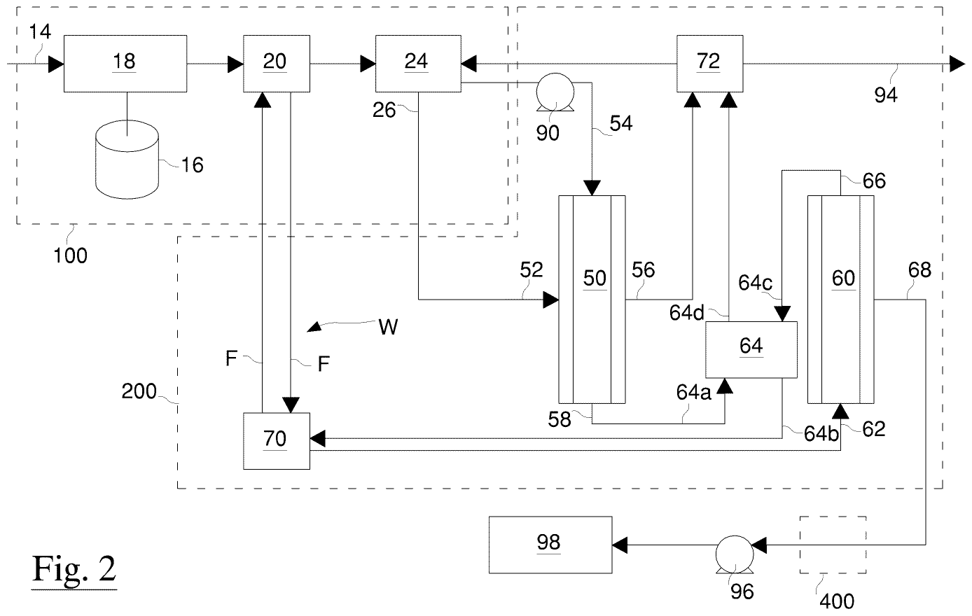

A variant of CO₂ extractor device from compressed air is shown in FIG. 2. In this variant also the electronic controller 300, the sensors 302, 304 and the controllers 306, 308 may be implemented.

Here, the absorbent fluid passes through the capture device 50 and downstream of the outlet 58 undergoes a preheating before reaching the heat exchanger 72. For this purpose, the absorbent fluid from the outlet 58 proceeds preferably to an inlet 64a of a heat exchanger 64 where it undergoes pre-heating, and then exits from an outlet 64a continuing to the heating element 70. Simultaneously from the outlet 66 the absorbent fluid is brought to an inlet 64c of the heat exchanger 64 where it is cooled by meeting the cooler fluid arriving from the outlet 58, and then proceeds from an outlet 64d of the heat exchanger toward the heat exchanger 72. Thus, the exchanger 64 offers the advantage of simultaneously heating absorbent fluid exiting from the capture device 50 and cooling absorbent fluid exiting from the release device 60 without external energy contribution. In addition, in this manner the cooling thermal coupling between the absorbent fluid and the dryer 24 is made efficiently.

Preferred temperature values for the scheme in FIG. 2 are: 3+5° C. at the inlet 54, about 6° C. at the outlet 58, about 75 to 80° C. at the outlet 70 of the heat exchanger, about 65 to 70° C. at the outlet 66, about 25 to 30° C. at the outlet 64 of the heat exchanger, and about 10 to 15° C. at the outlet of the intermediate heat exchanger 72. In a preferred variant one or each of the exchangers 64, 70, 72 is a plate heat exchanger, which favors maximum heat transfer, and/or a liquid-to-liquid heat exchanger.

In a variation, the devices 50, 60 may be replaced by a single membrane-device for the gas separation, thus avoiding the circuit for the absorbent fluid.

The examples described here referred to CO₂, but other gases or a vapor can also be extracted by adapting e.g. the devices 50, 60 and/or the absorbent fluid. The type of gas that can be extracted depends on the supply at the inlet 14. If there is compressed air at the inlet 14, one can extract water vapor (better than the dryer 24), oxygen, argon, helium, or any pollutants/impurities present in the working environment of the compressor 100 (e.g. organic solvents).

1. Method for extracting a gaseous or vapor component from compressed air produced by a compressor equipped with a compression chamber, wherein
the compressed air in the compression chamber is heated by the compression, is cooled at the outlet of the compression chamber, and sent to a capture device into which an absorbent fluid simultaneously enters and operates to purify it of said component, and
the absorbent fluid
exits enriched of said component from the capture device,
is heated by withdrawing heat generated by the compression process occurring in the compression chamber,
and then enters a release device wherein said component desorbs into the absorbent fluid to release, at an outlet of the release device, said component extracted from the compressed air.

2. Method according to claim 1, wherein the pressure of the absorbent fluid entering the capture device and the pressure of the compressed air entering the capture device are adjusted so that these two pressures are equal.

3. Method according to claim 1, wherein the compressed air passes from the compression chamber to a heat sink to be cooled therein, and the absorbent fluid exiting the capture device is heated by drawing heat dissipated from the heat sink.

4. Method according to claim 1, wherein the compressed air exits the compression chamber, enters a cooling device where it is cooled, and then arrives at the capture device.

5. Method according to claim 4, wherein the absorbent fluid sent to the inlet of the capture device is cooled in the cooling device or is cooled by exchanging heat with the cooling device.

6. Method according to claim 1, wherein the absorbent fluid exiting the release device is recirculated to the inlet of the capture device by passing through the cooling device to be cooled.

7. Method according to claim 1, wherein heat is transferred between the absorbent fluid exiting the release device and the compressed air exiting the capture device to cool the absorbent fluid and heat the compressed air.

8. Method according to claim 1, wherein the absorbent fluid exiting the capture device exchanges heat with the absorbent fluid exiting the release device, so that the absorbent fluid exiting the capture device heats up and the absorbent fluid exiting the release device cools down.

9. Apparatus comprising means for implementing the method according to claims 1.

10. Apparatus according to claim 9, comprising:
a compressor equipped with a compression chamber to produce compressed air,
a cooling device connected downstream of the compression chamber to cool compressed air at the outlet of the compression chamber,
a capture device configured to be traversed simultaneously by compressed air exiting the cooling device and an absorbent fluid for purifying the compressed air from said component,
a heating device for heating the absorbent fluid exiting the capture device, wherein the heating device is adapted to draw heat generated by the compression process taking place in the compression chamber,
a release device configured for being passed through by the absorbent fluid incoming from the heating device and, desorbing said component extracted from the compressed air.
